(19) United States
(12) Patent Application Publication
(10) Pub. No.: US 2020/0104781 A1
(43) Pub. Date: Apr. 2, 2020

(54) Career Pivot Intelligence

(71) Applicant: Microsoft Technology Licensing, LLC, Redmond, WA (US)

(72) Inventors: Karthik Dundee Jayachandar Naidu, Mountain View, CA (US); Xingyu Chen, Sunnyvale, CA (US); Kyle Wen Liu, Palo Alto, CA (US); Ka Ming Chan, Cupertino, CA (US); Hang Li, Sunnyvale, CA (US); Eduardo Monroy Martinez, Sunnyvale, CA (US); Vijay Ramamurthy, San Jose, CA (US); Himanshu Khurana, Milbrae, CA (US); Rohan Ramanath, Saratoga, CA (US); Luan Nguyen, Sunnyvale, CA (US)

(21) Appl. No.: 16/146,043

(22) Filed: Sep. 28, 2018

(51) Int. Cl. G06Q 10/06; G06Q 10/10

(52) U.S. Cl. CPC G06Q 10/063112; G06Q 10/1053

(57) ABSTRACT

The technical problem of automatically facilitating a career transition that is a career pivot is addressed by providing a career navigator component in an on-line connection network system. The career navigator is configured to determine that a member's intent is to pivot in their career and, in response, identify, rank, and surface member profiles that indicate the same pivot. The operations for recognizing a pivot intent include maintaining hierarchical occupation taxonomy that can be consulted to determine whether the member's activities on the web site relate to the same or different parent occupations. Once the pivot intent has been recognized, the career navigator identifies those member profiles that indicate the same career transition, and presents those profiles to the pivoting member via a custom-generated user interface.

### TECHNICAL FIELD

This application relates to the technical fields of software and/or hardware technology and, in one example embodiment, to system and method to facilitate a career transition for a member in an on-line connection network system.

### BACKGROUND

An on-line connection network is a platform for connecting people in virtual space. An on-line connection network may be a web-based platform, such as, e.g., a connection networking web site, and may be accessed by a user via a web browser or via a mobile application provided on a mobile phone, a tablet, etc. An on-line connection network may be a business-focused connection network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a connection networking web site may emphasize employment history and professional skills of the associated member. An on-line connection network is also configured to facilitate job-related searches.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to facilitate a career transition for a member in an on-line social network may be implemented;

FIG. 2 is block diagram of a system to facilitate a career transition for a member in an on-line social network, in accordance with one example embodiment;

FIG. 3 is a flowchart illustrating a method to facilitate a career transition for a member in an on-line social network, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to facilitate a career transition for a member in an on-line social network in an on-line connection network system are described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line connection networking application” and “an on-line connection network system” may be referred to as and used interchangeably with the phrase “an on-line connection network” or merely “a connection network.” It will also be noted that an on-line connection network may be any type of an on-line connection network, such as, e.g., a professional network, an interest-based network, or any on-line networking system that permits users to join as registered members. Each member of an on-line connection network is represented by a member profile (also referred to as a profile of a member or simply a profile). A member profile may be associated with connection links that indicate the member's connection to other members of the connection network. A member profile may also include or be associated with comments or recommendations from other members of the on-line connection network, with links to other network resources, such as, e.g., publications, etc. As mentioned above, an on-line connection networking system may be designed to allow registered members to establish and document networks of people they know and trust professionally. Any two members of a connection network may indicate their mutual willingness to be “connected” in the context of the connection network, in that they can view each other's profiles, profile recommendations and endorsements for each other and otherwise be in touch via the connection network. Members that are connected in this way to a particular member may be referred to as that particular member's connections or as that particular member's network. The profile information of a connection network member may include various information such as, e.g., the name of a member, current and previous geographic location of a member, current and previous employment information of a member, information related to education of a member, information about professional accomplishments of a member, publications, patents, as well as information about the member's professional skills. As mentioned above, an on-line connection network is also configured to facilitate job-related searches for members.

In a person's career there are moments when they consider making a career pivot. But making a career pivot can be nerve racking for a person since as it may well be an uncharted territory. Therefore, most people are interested in getting advice or at least seeing the career trajectory of other people that have made a similar career pivot. Once place a person can turn to is an on-line connection network made up of professionals to try to find someone that has made a similar career pivot. However, an on-line connection network can be made up of millions of members and finding someone with a similar career pivot can be nearly impossible because they don't offer searching capabilities for career pivots. The on-line network can suggest people that have made a similar career pivot but if the person does not explicitly indicate that he/she is interested in making a career pivot, the on-line network won't know to make the suggestion. Furthermore, there are likely to be hundreds or thousands of professionals that have made a similar career and the problem becomes, even if you determine that the person is interested in a career pivot, which of the thousands of professionals do you turn to for advice.

The technical problem of facilitating a career transition that is a career pivot with respect to job function or role, as well as with respect to industry, is addressed by providing a career navigator component in an on-line connection network system. The career navigator is configured to determine, automatically, that a member's intent is to pivot in their career and, in response, identify, rank, and surface member profiles that indicate the same pivot. The operations for recognizing a pivot intent include maintaining hierarchical occupation taxonomy that can be consulted to determine whether the member's activities on the web site relate to the same or different parent occupations. Once the pivot intent has been recognized, the career navigator identifies those member profiles that indicate the same career transition, and presents those profiles to the pivoting member with a suggestion that it may be helpful to reach out to those people for advice, all while addressing security and privacy concerns. For the purposes of this description, a member profile that is the subject of the process of determining a member's intent to pivot and to whom recommendations are surfaced is termed a subject member profile.

In one embodiment, a job seekers' pivot intent is identified by using certain signals detected in the on-line communication network system. These signals include the member's job view history, specified career interests, and job applies. If these jobs have a different parent occupation as compared to their current position's parent occupation, the career navigator tags the associated subject member profile with pivot intent flag. The process of identifying member profiles that manifest, by the associated behavior in the on-line connection network system, pivot intent is termed the demand side that informs the career navigator which members should be provided assistance in the form of surfacing to them the member profiles of those members who made the same career pivot. As mentioned above, the on-line communication network system maintains a hierarchical taxonomy of professional occupations, where a parent occupation, e.g., “software engineer” can have several related occupations—e.g., “senior software engineer,” “data analyst” and “user experience designer.” Thus if a job seeker's current position is “user experience designer,” which is associated with the parent occupation “software engineer” in the taxonomy and the viewed jobs have parent occupation “nursing” in the taxonomy, the career navigator tags the associated subject member profile with pivot intent flag. In some embodiments, a pivot intent is determined based on an industry related to the jobs being searched by a member being different from the industry related to their current job title or employer. The industry associated with job-seeker's current occupation can be derived from an identification of an employer associated with a current job indicated in the subject member profile representing the job seeker.

For the purposes of this description, career pivot is defined as moving from one parent occupation to another (e.g., from Software Engineer to Product Manager) or moving from one industry to another (e.g., from Healthcare to Tech).

The process of selecting those member profiles that indicate a career pivot made by the associated member as the pivot intended by a job seeker represented by the subject member profile is referred to as the supply side for generating pivot member recommendations. In one embodiment, the member profiles that indicate the same career transition intended by the job seeker represented by the subject member profile are selected from these three groups of members—mentors who have signed up in the opportunity marketplace in the on-line communication network system, premium members with open profile setting in the on-line communication network system, and the job-seeker's 1 st degree connections in the on-line communication network system. By looking at their current and past job positions the career navigator determines if they have made a pivot in their careers. Once the member profiles representing members who have made a career pivot have been identified, these member profiles (referred to as candidate member profiles) are grouped by transition type and the profiles in each group are ranked. Those member profiles that have higher quality match with the transition indicated by the job-seeking activity associated with the subject member profile are ranked higher than those member profiles that have lower quality match with said transition. For example, a member profile manifesting a more recent transition from a position corresponding to the job-seeker's current position to the position corresponding to the job-seeker's desired pivot (the target position) can be ranked higher than a member profile manifesting a less recent transition from a position corresponding to the job-seeker's current position to the target position. In some embodiments, a machine learning model that be configured to dynamically improve and personalize the recommended member ranking for each transition group.

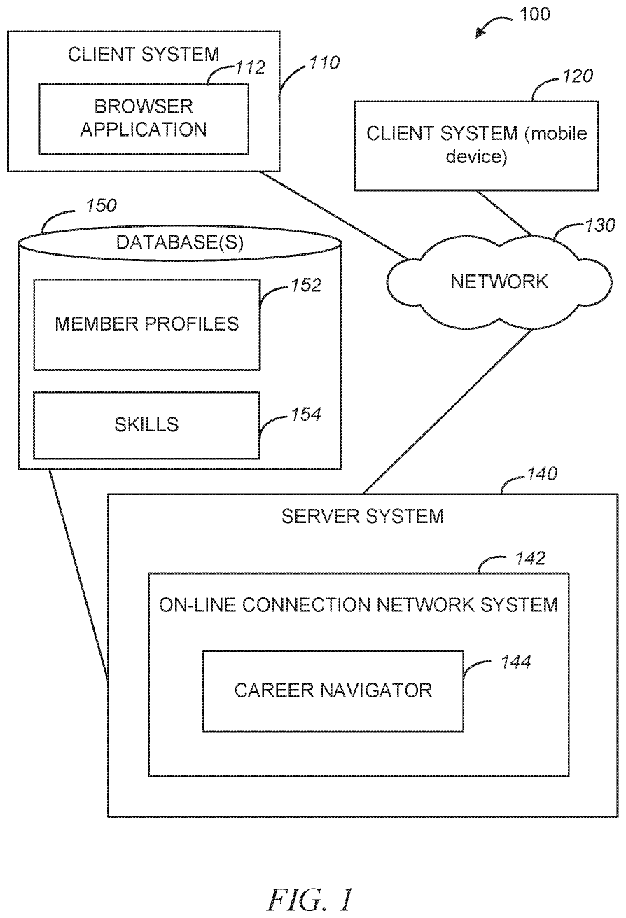

The highest-ranked member profiles from the set of candidate member profiles are surfaced to the job-seeker via a user interface (UI) that includes information about the profiles and their respective career pivot detail, respective visual controls that can be activated to view the associated member profiles, as well as an explanation of why these recommended member profiles are being shown to the job seeker (e.g., “Get advice from people who transitioned to Product Manager. Recommended to you because you viewed three Product Manager jobs.”). In some embodiments, respective sets of member profiles associated with different career pivots are generated and stored, and then a set associated with the pivot determined with respect to a subject member is accessed and ranked. An example career navigator may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line connection network system 142. As explained above, each member of an on-line connection network is represented by a member profile that contains personal and professional information about the member and that may be associated with connection links that indicate the member's connection to other member profiles in the on-line connection network. Member profiles and related information may be stored in a database 150 as member profiles 152. The database 150 also stores skills 154.

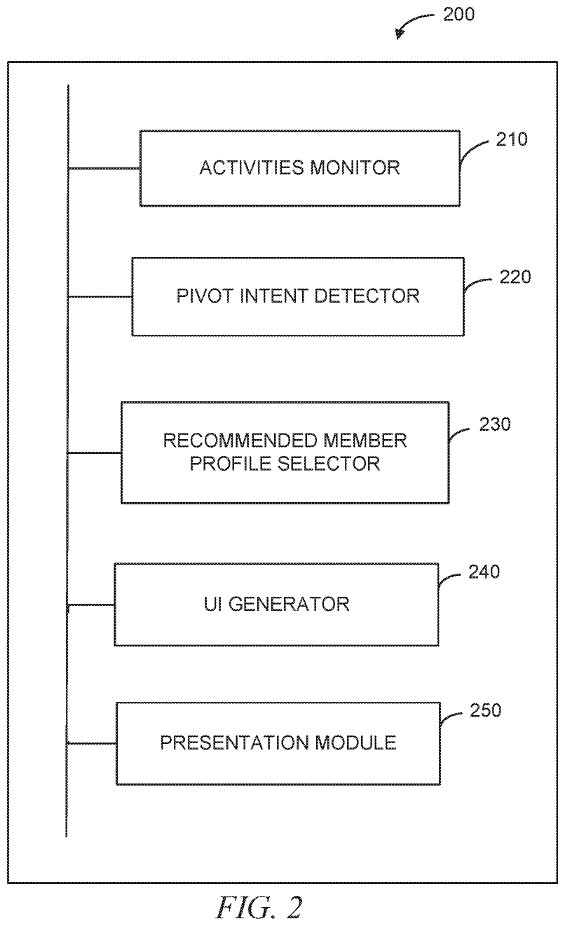

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a career navigator 144. The career navigator 144 is configured to facilitate a career transition for a member in an on-line social network, applying methodologies discussed herein. An example career navigator 144 is illustrated in FIG. 2.

FIG. 2 is a block diagram of a system 200 to facilitate a career transition for a member in an on-line social network. As shown in FIG. 2, the system 200 includes an activities monitor 210, a pivot intent detector 220, a recommended member profile selector 230, a UI generator 240, and a presentation module 250. The activities monitor 210 monitors activities originated with a subject member profile in an on-line connection network system. The pivot intent detector 220 detects, from the monitored activities, an indication of a career pivot intent associated with a target occupation. The detecting of the indication of the career pivot intent associated with the target occupation from the monitored activities comprises detecting a certain number of job views originated with the subject member profile in a certain period of time and associated with the target occupation, and also determining that the target occupation is a pivot with respect to current occupation identified in the subject member profile. In some embodiments, the current occupation identified in the subject member profile is represented by a string stored in a title field of the subject member profile. The indication of a career pivot intent may be specified as a certain number of pivot indicator events in a rolling time window, each of the pivot indicator events detected in the on-line connection network system, associated with the target occupation, and originated with the subject member profile. Examples of pivot indicator event include job views, job searches, job applies, as well as following companies associated with a specific industry. As mentioned above an occupation taxonomy database is maintained in the on-line connection network system, wherein the detecting of the indication of the career pivot intent associated with the target occupation comprises determining, from the occupation taxonomy database, that the target occupation is associated with a first parent occupation and that information indicated in a current title field of the subject member profile with a second parent occupation.

The recommended member profile selector 230 selects a candidate set of recommended member profiles in response to the detecting of the indication of career pivot intent associated with the target occupation, such that each profile in the candidate set of recommended member profiles includes an indication of a career pivot from a job corresponding to a current occupation identified in the subject member profile to a job corresponding to the target occupation. In some embodiments, the candidate set of recommended member profiles is selected from previously generated plurality of sets of pivoted member profiles, where each set in the plurality of sets of pivoted member profiles is characterized by an associated career pivot. For example, one set of pivoted member profiles may include profiles representing members who pivoted from Tech industry to Healthcare industry, while another set of pivoted member profiles may include profiles representing members who pivoted from Software Engineer position to Product Manager position.

The recommended member profile selector 230 also calculates respective ranks associated with profiles in the candidate set of member profiles based on similarity between the target occupation and information indicated in a current title field of a member profile from the candidate set of member profiles and also based on similarity between information indicated in a current title field of the subject member profile and information indicated in a previous position field of member profile from the candidate set of member profiles. The recommended member profile selector 230 selects one or more profiles from the candidate set of member profiles to be included in the recommended members UI, based on respective ranks associated with the profiles in the candidate set of member profiles. In some embodiments, each profile in the candidate set of recommended member profiles is at least one of: a connection of the subject member profile or includes an indication of a consent to be contacted by a user represented by the subject member profile.

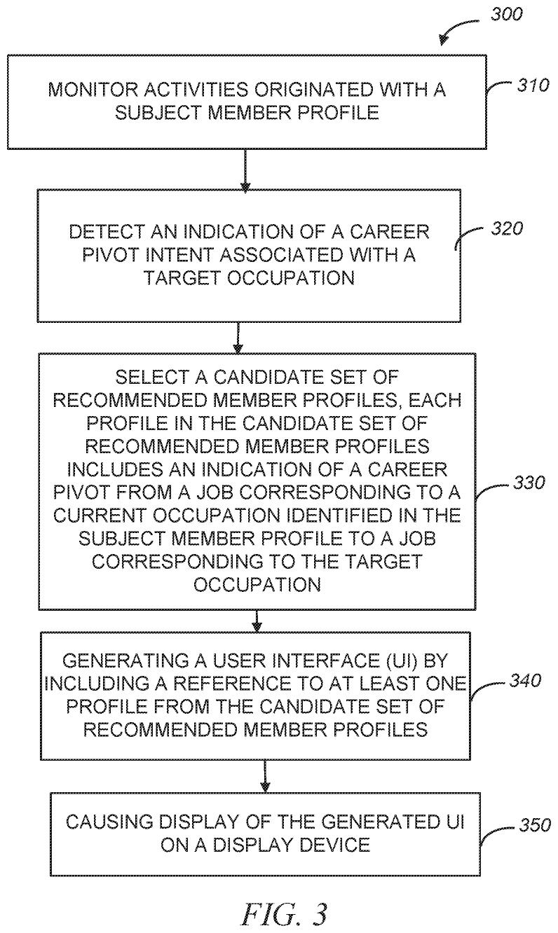

The UI generator 240 generates a recommended members UI by including, into the UI a reference to at least one profile from the candidate set of recommended member profiles. The presentation module 250 is configured to cause presentation of the generated recommended members UI on a display device. Some operations performed by the system 200 may be described with reference to FIG. 3.

FIG. 3 is a flowchart of a method 300 to facilitate a career transition for a member in an on-line social network 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the activities monitor 210 monitors activities originated with a subject member profile in an on-line connection network system. At operation 320, the pivot intent detector 220 detects, from the monitored activities, an indication of a career pivot intent associated with a target occupation. The recommended member profile selector 230 selects, at operation 330, a candidate set of recommended member profiles in response to the detecting of the indication of career pivot intent associated with the target occupation, such that each profile in the candidate set of recommended member profiles includes an indication of a career pivot from a job corresponding to a current occupation identified in the subject member profile to a job corresponding to the target occupation. At operation 340, the UI generator 240 of FIG. 2 generates a recommended members UI by including, into the UI a reference to at least one profile from the candidate set of recommended member profiles. The presentation module 250 of FIG. 2 causes presentation of the generated recommended members UI on a display device, at operation 350.

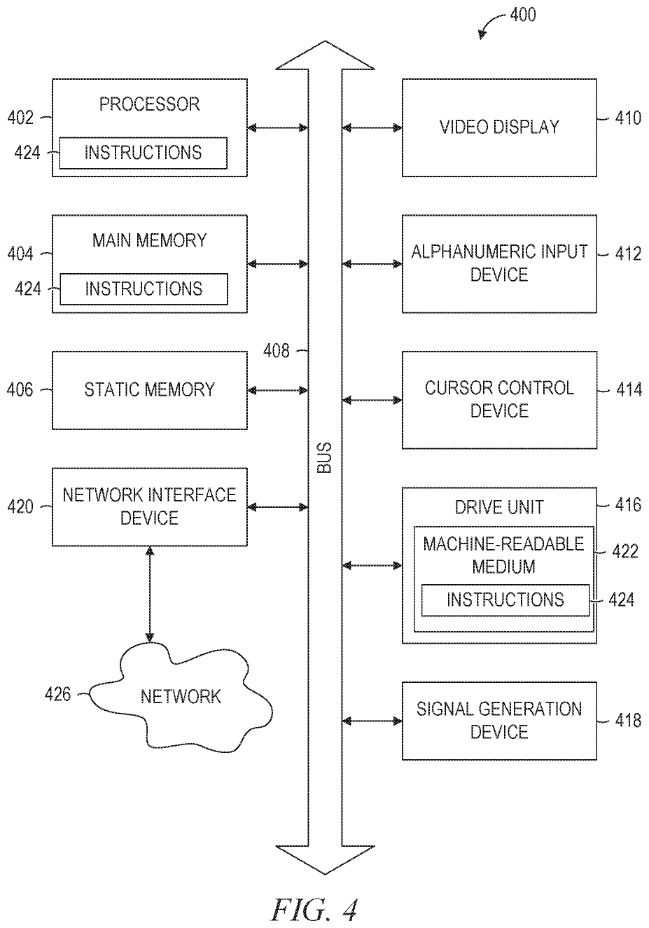

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to facilitate a career transition for a member in an on-line social network has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer implemented method comprising:
monitoring activities originated with a subject member profile in an on-line connection network system;
detecting, from the monitored activities, an indication of a career pivot intent associated with a target occupation;
in response to the detecting of the indication of career pivot intent associated with the target occupation, selecting a candidate set of recommended member profiles, each profile in the candidate set of recommended member profiles includes an indication of a career pivot from a job corresponding to a current occupation identified in the subject member profile to a job corresponding to the target occupation; and
generating a recommended members user interface (UI) by including, into the UI a reference to at least one profile from the candidate set of recommended member profiles; and
causing presentation of the recommended members UI on a display device.

2. The method of claim 1, wherein the detecting of the indication of the career pivot intent associated with the target occupation from the monitored activities comprises: detecting a certain number of job views originated with the subject member profile in a certain period of time and associated with the target occupation; and determining that the target occupation is a pivot with respect to current occupation identified in the subject member profile.

3. The method of claim 1, wherein the current occupation identified in the subject member profile is represented by a string stored in a title field of the subject member profile.

4. The method of claim 1, wherein the selecting of the candidate set of recommended member profiles is from previously generated plurality of sets of pivoted member profiles, each set in the plurality of sets of pivoted member profiles characterized by an associated career pivot.

5. The method of claim 1, wherein the indication of the career pivot intent is a certain number of pivot indicator events in a rolling time window, each of the pivot indicator events detected in the on-line connection network system, associated with the target occupation, and originated with the subject member profile.

6. The method of claim 1, comprising:
calculating respective ranks associated with profiles in the candidate set of member profiles based on similarity between the target occupation and information indicated in a current title field of a member profile from the candidate set of member profiles and also based on similarity between information indicated in a current title field of the subject member profile and information indicated in a previous position field of member profile from the candidate set of member profiles; and
selecting one or more profiles from the candidate set of member profiles to be included in the recommended members UI, based on respective ranks associated with the profiles in the candidate set of member profiles

7. The method of claim 1, comprising maintaining occupation taxonomy database, wherein the detecting of the indication of the career pivot intent associated with the target occupation comprises determining, from the occupation taxonomy database, that the target occupation is associated with a first parent occupation and that information indicated in a current title field of the subject member profile with a second parent occupation.

8. The method of claim 1, wherein the subject member profile includes an indication of a preferred member.

9. The method of claim 1, wherein each profile in the candidate set of recommended member profiles is at least one of: a connection of the subject member profile or includes an indication of a consent to be contacted by a user represented by the subject member profile.

10. The method of claim 1, wherein the current occupation represents an industry identification, the method comprising deriving the current occupation identified in the subject member profile from an identification of an employer associated with a current job indicated in the subject member profile.

11. A system comprising:
one or more processors; and
a non-transitory computer readable storage medium comprising instructions that when executed by the one or processors cause the one or more processors to perform operations comprising:
monitoring activities originated with a subject member profile in an on-line connection network system;
detecting, from the monitored activities, an indication of a career pivot intent associated with a target occupation;
in response to the detecting of the indication of career pivot intent associated with the target occupation, selecting a candidate set of recommended member profiles, each profile in the candidate set of recommended member profiles includes an indication of a career pivot from a job corresponding to a current occupation identified in the subject member profile to a job corresponding to the target occupation; and
generating a recommended members user interface (UI) by including, into the UI a reference to at least one profile from the candidate set of recommended member profiles; and
causing presentation of the recommended members UI on a display device.

12. The system of claim 11, wherein the detecting of the indication of the career pivot intent associated with the target occupation from the monitored activities comprises: detecting a certain number of job views originated with the subject member profile in a certain period of time and associated with the target occupation; and determining that the target occupation is a pivot with respect to current occupation identified in the subject member profile.

13. The system of claim 11, wherein the current occupation identified in the subject member profile is represented by a string stored in a title field of the subject member profile.

14. The system of claim 11, wherein the selecting of the candidate set of recommended member profiles is from previously generated plurality of sets of pivoted member profiles, each set in the plurality of sets of pivoted member profiles characterized by an associated career pivot.

15. The system of claim 11, wherein the indication of the career pivot intent is a certain number of pivot indicator events in a rolling time window, each of the pivot indicator events detected in the on-line connection network system, associated with the target occupation, and originated with the subject member profile.

16. The system of claim 11, comprising:
calculating respective ranks associated with profiles in the candidate set of member profiles based on similarity between the target occupation and information indicated in a current title field of a member profile from the candidate set of member profiles and also based on similarity between information indicated in a current title field of the subject member profile and information indicated in a previous position field of member profile from the candidate set of member profiles; and
selecting one or more profiles from the candidate set of member profiles to be included in the recommended members UI, based on respective ranks associated with the profiles in the candidate set of member profiles

17. The system of claim 11, comprising maintaining occupation taxonomy database, wherein the detecting of the indication of the career pivot intent associated with the target occupation comprises determining, from the occupation taxonomy database, that the target occupation is associated with a first parent occupation and that information indicated in a current title field of the subject member profile with a second parent occupation.

18. The system of claim 11, wherein the subject member profile includes an indication of a preferred member.

19. The system of claim 11, wherein each profile in the candidate set of recommended member profiles is at least one of: a connection of the subject member profile or includes an indication of a consent to be contacted by a user represented by the subject member profile.

20. A machine-readable non-transitory storage medium having instruction data executable by a machine to cause the machine to perform operations comprising:
monitoring activities originated with a subject member profile in an on-line connection network system;
detecting, from the monitored activities, an indication of a career pivot intent associated with a target occupation;
in response to the detecting of the indication of career pivot intent associated with the target occupation, selecting a candidate set of recommended member profiles, each profile in the candidate set of recommended member profiles includes an indication of a career pivot from a job corresponding to a current occupation identified in the subject member profile to a job corresponding to the target occupation; and
generating a recommended members user interface (UI) by including, into the UI a reference to at least one profile from the candidate set of recommended member profiles; and
causing presentation of the recommended members UI on a display device.
